(19) United States
(12) Patent Application Publication
(10) Pub. No.: US 2011/0219974 A1
(43) Pub. Date: Sep. 15, 2011

(54) Overprinting System and Method

(75) Inventors: Eli Grinberg, Kfar Sava (IL); Kobi Bar, Kefar Sava (IL)

(73) Assignee: Scodix, Ltd., Rosh Haayin (IL)

(21) Appl. No.: 12/682,163

(22) PCT Filed: Oct. 6, 2008
(86) PCT No.: PCT/IL08/01323

§ 371 Date: May 16, 2011

Related U.S. Application Data
(60) Provisional application No. 60/960,637, filed on Oct. 9, 2007.

(51) Int. Cl. B41L 3/02

(52) U.S. Cl. 101/481; 101/486

(57) ABSTRACT

An adaptive overprint system for providing an overprint upon a substrate; the substrate comprising a plurality of registration markers at predetermined locations thereon and at least one pre-printed feature; the system comprising: an imager for capturing a digital image of said substrate with said registration markers and said feature; a printing platform upon which the substrate resides during overprinting; a printing mechanism for stamping said overprint upon said pre-printed feature; a controller operatively connected to said imager and said printing mechanism; and a handling device to move the substrate in and out of the printer; wherein said controller is adapted to identify and calculate the shift in said pre-printed feature based on said image of the substrate received from said imager, and to calculate a correlating compensation or correction shift to be electronically applied to the overprinted image.

### FIELD OF THE INVENTION

The present invention relates to overprinting, and more particularly to adaptive corrected overprinting.

### BACKGROUND OF THE INVENTION

Overprinting is the intentional printing of one or more layers of ink, or other such printing media, on top of another, for example by coating or varnishing. In this manner, a previously printed media can be enhanced, for example, with a glossy finish. The overprint or overcoat can be on the entire media or substrate, on one or more features previously printed on the substrate or be printing printed adjacent to previously printed features, or any combination of these.

To print on specific features and produce a high quality overprint, it is critical that the overprint ink be accurately applied on the substrate. For this purpose, the overprint coating applicator, for example, an ink-jet nozzle, must be accurately aligned with the features to be coated.

Another example of overprinting one in which a symbol or text, etc, is printed after-a first printing, and the overprinting is printed adjacent or in proximity to, but not necessarily directly over, the symbol or text.

U.S. Pat. No. 4,857,715 (Koch et al) discloses a scannable form for an optical mark scanning apparatus in the form of a generally rectangular sheet of paper or like material having a preprinted timing track along one edge and a plurality of preprinted quality assurance marks is printed by a laser printer with customized questions and corresponding response bubbles to create a survey form. An overprint registration system is used in conjunction with the scannable forms to align material for printing on the scannable forms prior to printing the survey form by printing an overprint registration mark corresponding to at least one of the quality assurance marks and adjusting the position of the overprint registration mark to establish the alignment between the response bubbles to be printed and the preprinted timing track. The system may also include a verification process wherein a plurality of alignment marks will be overprinted in the position of the overprint registration marks during the printing of the survey form, so that the alignment of each form in relation to the quality assurance marks may be verified during scanning.

U.S. Pat. No. 5,600,350 (Cobbs et al) describes an image registration system for a multicolor inkjet printer/plotter. The system comprises a carriage assembly for retaining multiple inkjet cartridges. Each cartridge has a plurality of nozzles adapted to eject ink in response to the application of an electrical signal thereto. A first mechanism is provided for moving the carriage assembly means in a first axis. A second mechanism is provided for moving print media in a second axis transverse to the first axis, the first axis being a scan axis and the second axis being a media axis. A first position encoder senses the position of the carriage assembly in the first axis and a second position encoder senses the carriage assembly in the second axis and providing position encoder signals in response thereto. A control circuit provides electrical signals which cause the nozzles in the inkjet cartridges to eject ink onto the media and create an image thereon in response to timing signals. The system includes a sensor module which optically senses the image and provides a set of sensed signals in response thereto. The sensed signals are processed to provide timing signals for use in correcting the image miss-registration.

U.S. Pat. No. 6,454,383 (Lund et al) provides a method and apparatus for a test pattern used in the alignment of an ink-jet pen which deposits fixer fluid, or other clear ink precursor fluid, on print media uses the change in reflectivity caused by overprinting a series of positional-calibration indicia with colorant to obtain data with respect to deviations in a carriage-scan x-axis and a paper scan y-axis. Thus the invention measures distances between pens or nozzles.

U.S. Pat. No. 5,803,504 (Deshiens et al) describes a method of producing a lottery ticket with an overprint region provided over a scratch-off layer. To ensure proper alignment of printing layers of the overprint region, photocell devices are installed at each of the stations of press maybe linked to various controls of the paper feeding mechanism of the press. Preferably, the registration devices in the flexographic press should allow no more than a 0.005 inch (0.013 cm) variation on each station.

U.S. Pat. No. 6,840,173 (Kawabata et al) discloses a plate cylinder and printing plate holder for the cylinder, which is capable of adjusting relative positions of plural printing plate holders and fixing the printing plate holders on the plate cylinder without causing misalignments of images among printing plates held by the printing plate holders even after overprinting. The plate cylinder is equipped with at least two printing plates wrapped around the outer circumference thereof. The plate cylinder comprises printing plate holders, one per each printing plate, for holding the printing plates on the outer circumference of the plate cylinder. The printing plate holders include one printing plate holder in a stationary state and fixed against the plate cylinder and other printing plate holders that are adjustable to move in the circumferential direction of the plate cylinder and fixable against the plate cylinder.

To aid in applying the overprint coating accurately, prior art relies on registration markers, typically in the form of cross hairs, located in two corners of the substrate. However, during the pre-overprinting print, registration markers and the specific features may be misaligned; i.e. moved from their intended location in an x-direction, and/or a y-direction, and/or at an angle, and/or due to scaling (enlargement/reduction) and so on. Other types of misalignment can also be present, as will be discussed in more detail below.

It is therefore a long felt need to disclose a means and method for overprinting that overcomes the difficulty of identifying a misalignment between registration markers and pre-printed features, such that the overprint is not aligned in accordance with said registration markers, but rather in accordance with said pre-printed features. Moreover, it is a long felt need to address a plurality of printing shifts beyond misalignment, namely global shift, a local shift, a linear shift, an angular shift, a size shift, an intensity shift, a color shift, or any combination thereof.

### SUMMARY OF THE INVENTION

It is an object of the present invention to disclose an adaptive overprint system for providing an overprint upon a substrate; the substrate comprising a plurality of registration markers at predetermined locations thereon and at least one pre-printed feature; the system comprising: an imager for capturing a digital image of said substrate with said registration markers and said feature; a printing platform upon which the substrate resides during overprinting; a printing mechanism for stamping said overprint upon said pre-printed feature; a controller operatively connected to said imager and said printing mechanism; and a handling device to move the substrate in and out of the printer; wherein said controller is adapted to identify and calculate the shift in said pre-printed feature based on said image of the substrate received from said imager, and to calculate a correlating compensation or correction shift to be electronically applied to the overprinted image.

It is within the scope of the above mentioned overprint system that the above mentioned shift is selected from a group consisting of: a global shift, a local shift, a linear shift, an angular shift, a size shift, an intensity shift, a color shift, or any combination thereof.

The overprint system as defined above additionally comprising a means for storing a log of the substrates identified as requiring shift adaptive overprint intervention.

It is within the scope of the above mentioned overprint system, additionally comprises a sorting means for stacking adaptively overprinted substrates separately from overprinted substrates that did not require shift adaptive intervention.

It is within the scope of the above mentioned overprint system, additionally comprises a means for marking substrates that have undergone shift adaptive overprinting.

It is within the scope of the above mentioned overprint system, additionally comprises a computerized means for selecting shifts that should be discarded, said shifts selected from a group consisting of: a global shift, a local shift, a linear shift, an angular shift, a size shift, an intensity shift, a color shift, or any combination thereof.

It is within the scope of the present invention that the above mentioned printing mechanism comprises an inkjet printing head.

It is within the scope of the present invention that the above mentioned overprint system is adapted to produce a UV spot coating.

It is yet another object of the present invention to disclose a method of adaptive overprinting on a substrate having a plurality of registration markers at predetermined locations thereon that has been pre-printed with at least one feature, said feature having being printed with a shift , the method comprising steps of: obtaining an adaptive overprint system for providing an overprint upon a substrate; the substrate comprising a plurality of registration markers at predetermined locations thereon and at least one pre-printed feature; the system comprising: an imager for capturing a digital image of said substrate with said registration markers and said feature; a printing platform upon which the substrate resides during overprinting; a printing mechanism for stamping said overprint upon said pre-printed feature; a controller operatively connected to said imager and said printing mechanism; and a handling device to move the substrate in and out of the printer; capturing a digital image of the substrate, comprising capturing said plurality of registration markers and said feature to be overprinted; producing image data related to the shift in said captured image; analyzing said image data to produce an appropriately shifted printing instructions; overprinting on the substrate in accordance with said shifted printing instruction, and thereby aligning said overprint with said pre-printed feature by shifting said overprint to match said original shift in said pre-printed feature.

It is within the scope of the present invention that the above mentioned shift is selected from a group consisting of: a global shit, a local shift, a linear shift, an angular shift, a size shift, an intensity shift, a color shift, or any combination thereof.

It is within the scope of the present invention that the above mentioned method of adaptive overprinting, additionally comprises a step of storing a log of the substrates requiring shift adaptive overprint intervention.

It is within the scope of the present invention that the above mentioned method of adaptive overprinting, additionally comprises a step of sorting said overprinted substrates and stacking adaptively overprinted substrates separately from overprinted substrates that did not undergo shift adaptive intervention.

It is within the scope of the present invention that the above mentioned method of adaptive overprinting, additionally comprises, additionally comprises a step of marking substrates that have undergone shift adaptive overprinting.

It is within the scope of the present invention that the above mentioned method of adaptive overprinting, additionally comprises a step of selecting shifts that should be discarded, said shifts selected from a group consisting of: a global shift, a local shift, a linear shift, an angular shift, a size shift, an intensity shift, a color shift, or any combination thereof; and consequently discarding substrates identified as having said selected shifts.

It is yet another object of the present invention to disclose a method of compensating or correcting for shift or printing anomaly on a pre-printed substrate, comprising the steps of obtaining an adaptive overprint system for providing an overprint upon a substrate; the substrate comprising a plurality of registration markers at predetermined locations thereon and at least one pre-printed feature; the system comprising: an imager for capturing a digital image of said substrate with said registration markers and said feature; a printing platform upon which the substrate resides during overprinting; a printing mechanism for stamping said overprint upon said pre-printed feature; a controller operatively connected to said imager and said printing mechanism; and a handling device to move the substrate in and out of the printer; positioning said substrate in an overprinting system; capturing an image of said substrate to produce image data; analyzing said image data to determine a suitable compensation for overprinting; and, actuating a printing mechanism to print on the substrate according to the determined compensation.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a perspective view of an embodiment of a printing system for overprinting on a substrate of the present invention;

FIG. 2 is an elevated view of a substrate having a feature disposed in its designed location (with no offset);

FIGS. 3A-3H are elevated views of substrates with an exemplary offsets that can accurately overprinted by the printing system of the present invention; and

FIG. 4 is a flowchart depicting an embodiment of a method of the present invention.

### DESCRIPTION OF EMBODIMENTS OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for adaptive overprinting.

The term ‘handling device’ refers hereinafter to the devices or mechanisms for feeding a substrate into a printing device, for holding the substrate during printing and for expelling the substrate after printing.

The term ‘plurality’ refers hereinafter to any integer number equal or higher than one, e.g., 2, 3, 4, etc.

The terms ‘shift’ or ‘printing shift’ are used interchangeably hereinafter in the broadest manner including a longitudinal and/or lateral disposition (i.e. x-y or Cartesian coordinate skew; also know as a linear shift); an angular shift or disposition (i.e. polar coordinate type); a size shift (e.g. due to an enlargement or size reduction anomaly of any or all features or portion(s) thereof); a local shift (i.e. wherein only one or some—or portions thereof—of features contain anomalies or deviations; an intensity shift (i.e. the intensity or boldness or portion thereof deviates from the designed intensity a color shift wherein the color or shade of a feature(s) appearing on the substrate are not as intended (e.g. fading due to age or sun exposure, dirt, chemicals, etc) or the color shift is used to determine a proper color for matching a color to be printed adjacent to the feature(s). Aside from the local shifts, the aforementioned shift types may be categorized as “global shifts” if the feature(s) are affected (shifted, etc.) in an analogous manner to the registration markers.

The aforementioned meanings and explanations of the interchangeable terms misalignment, skew and shift should become clearer upon reading of the detailed description.

The term ‘substrate’ is used in its broadest meaning and includes any medium that can be printed upon, for example, paper, plastic, wood, metal, films and so on.

The ‘pre-printed feature’ refers hereinafter to any image or markings that have stamped upon a substrate prior to being introduced to the overprint system.

Advantages of the overprinting system and method of the present invention include:

1. It does not require set up and does not require plates, screens or pre-press preparation.

2. It can be used for flood coating or spot coating, e.g. a UV spot coating.

3. It is conveniently used with most common paper sizes in the conventional and digital printing industry.

4. The coating is determined directly from a computer file.

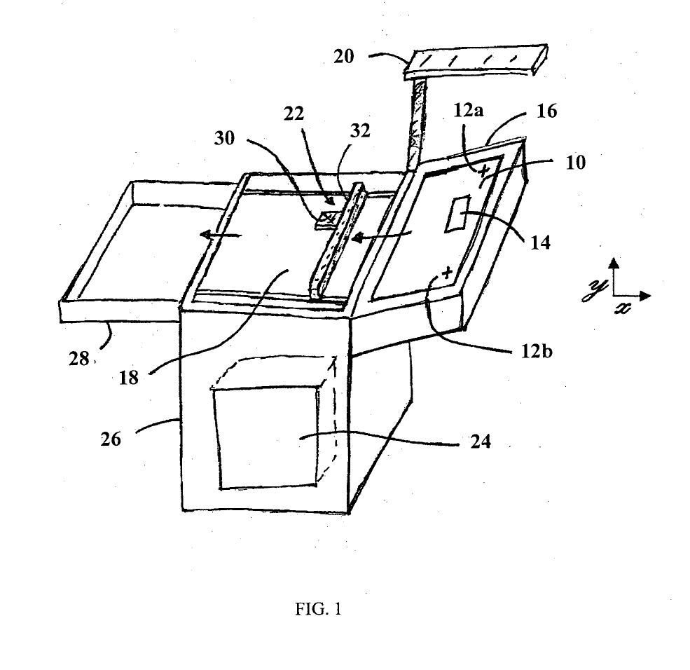

FIG. 1 shows an embodiment of an overprinting system of the present invention for printing on a substrate 10, for example a sheet of paper and the like. The substrate 10 has a pair of registration markers 12a and 12b, typically in the form of cross hairs, located in two corners of thereof. The substrate 10 further comprises a feature 14 from a previous printing thereon, shown as a square for demonstration purposes only. The system comprises a paper feeder 16, a platform 18 for receiving the substrate 10, an imaging device or imager 20, a printing mechanism 22 and a control module or controller 24, shown housed in a housing or cabinet 26. The controller 24 is operationally connected to the imager 20 and printing mechanism 22.

The system also comprises a device (not seen) for moving the paper 10 from the platform 18 where printing occurs to any following stage, for example, exposure to UV radiation to dry the overprinting ink, in the case of a UV spot coating. Such following stage is represented schematically by tray 28.

In accordance with particular embodiments, the printing mechanism 22 comprises a printing head such as an ink-jet nozzle 30 or a plurality thereof (only one shown), and a mechanism for holding and moving the ink-jet nozzle such as a moveable bar 32. The printing mechanism 22 may be designed to move the ink-jet nozzle 30 in both the x-direction and y-direction, for example by moving the ink-jet nozzle 30 along the bar 32 (e.g. in the x-direction) and moving the bar (e.g. in the y-direction) over the substrate 10 when it resides on the platform 18. It should be understood that other printing mechanisms may be used, for example, a laser printing mechanism (not shown).

The imager 20 is typically an optical imager whose function and mechanism can constituted by a variety of means, for example it may be housed in the bar 32 and scan the substrate 10. Likewise, it should be understood that other ink-jet nozzle movement options can be devised, one example being wherein the substrate 10 is moved is one or both of the x-direction and/or y-direction—or in combination with the printing mechanism 22.

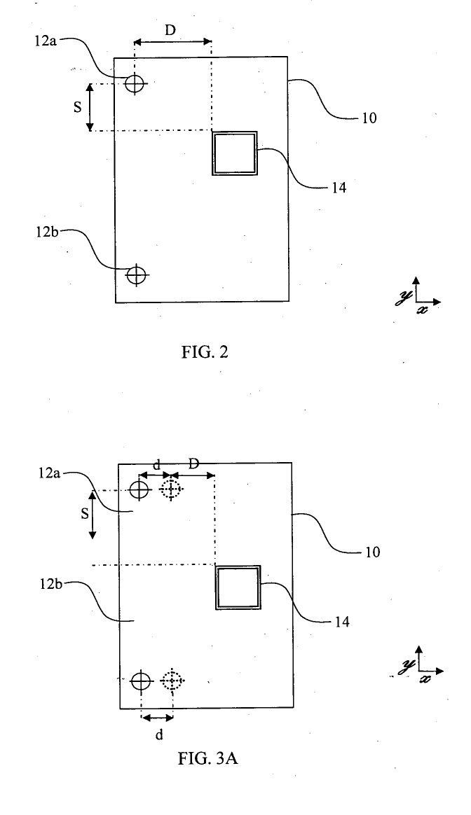

FIG. 2 shows the substrate 10 with its registration markers 12a and 12b in their intended locations. These registration markers 12a and 12b are standard commercially utilized markers. For explanation purposes, the feature 14 is shown a distance of “D” units in the x-direction from the registration marker 12a and a distance of “S” units in the y-direction from that marker. However, due to offset(s), the location of the registration markers 12a and 12b are not in their intended locations.

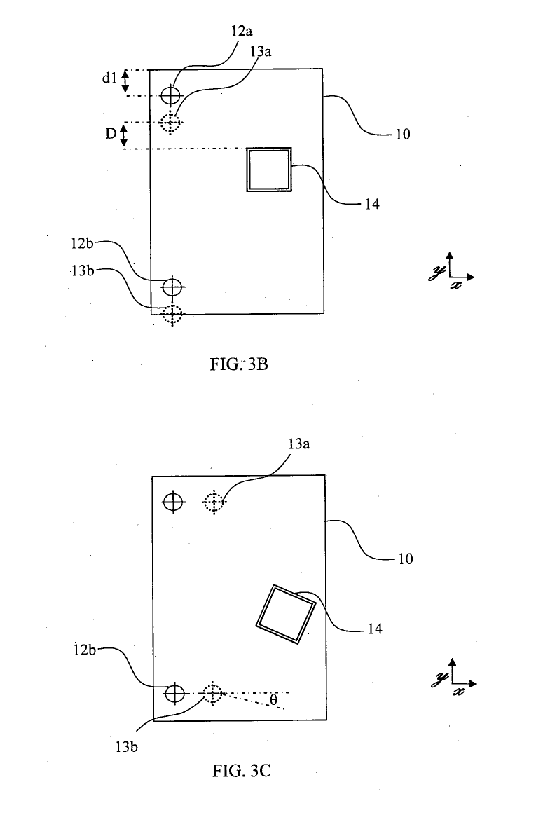

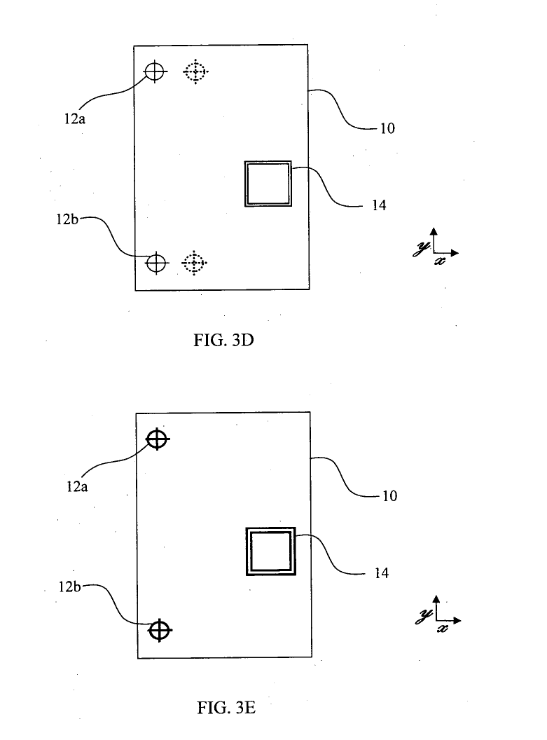

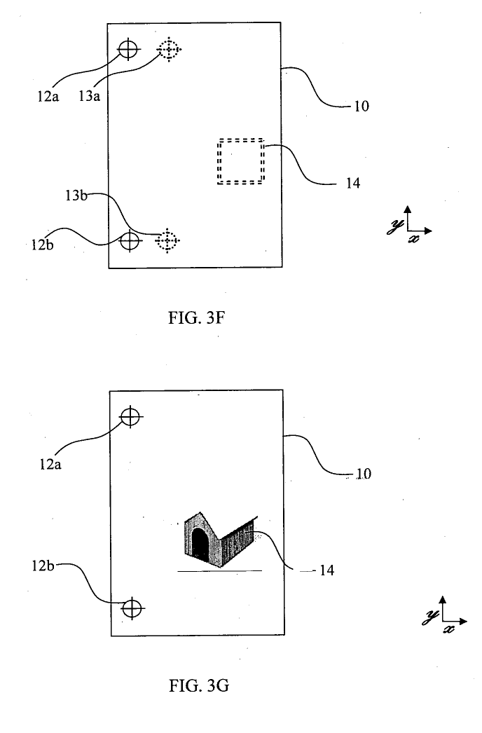

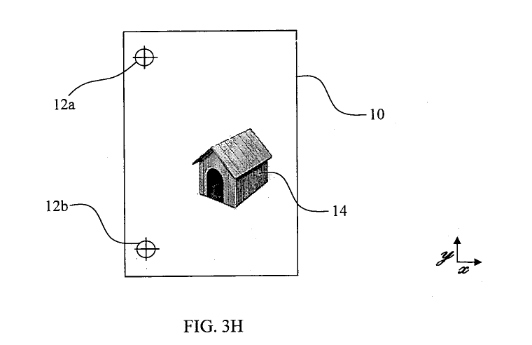

FIG. 3A shows a first example of a possible offset wherein the registration markers 12a and 12b are not in their intended locations. In this example, the registration markers 12a and 12b are shifted or translated a distance “d” in the x-direction from those intended locations. For explanation purposes, the shifted registration marks are shown using dashed lines and their actual positions are designated 13a and 13b, respectively. These reference numerals will be used throughout in regard to global positional and size offsets (as compared to local offsets, intensity offsets and color offsets, which will be discussed below).

Prior to applying the overprint, the imager 20 images the substrate 10 and thereby determines and quantifies the aforementioned shift, i.e. the actual locations 13a and 13b of the registration markers 12a and 12b and that the shift is “d” units in the x-direction. The feature 14 is therefore determined to be “d” units in the x-direction. This information is conveyed to the controller 24 which in turn actuates and controls the printing mechanism 22 to compensate for this offset. Thus an accurate overprinting can be performed.

FIG. 3B shows another example of a possible offset wherein the registration markers 12a and 12b are not in their intended locations. In this example, the registration markers 12a and 12b are shifted or translated a distance “d1” in the y-direction from those intended locations.

In a similar manner as described with reference to FIG. 3A, prior to, applying the overprint, the imager 20 images the substrate 10 and thereby determines and quantifies the aforementioned shift, i.e. the actual locations 13a and 13b of the registration markers 12a and 12b and that the shift is “d1” units in the y-direction. The feature 14 is therefore determined to be “d1” units in the y-direction. This information is conveyed to the controller 24 which in turn actuates and controls the printing mechanism 22 to compensate for this offset so that an accurate overprinting can be obtained.

FIG. 3C shows yet another example of a possible offset wherein the registration markers 12a and 12b are not in their intended locations. In this example, the registration markers 12a and 12b are turned or angled at an angle “theta”. For convenience of displaying this offset, the actual positions 13a and 13b will be displayed as having an x-direction offset as well (however, the feature 14 is not shifted). It should be understood that any and all combinations of offsets, those already described, those yet to be described, and those not described herein but falling within the scope of the claimed invention, can occur separately or in combination.

Again, prior to applying the overprint, the imager 20 images the substrate 10 and thereby determines and quantifies the aforementioned shift, i.e. the actual locations 13a and 13b of the registration markers 12a and 12b and that the offset is an angle “theta” (and any x-direction and/or y-direction units shift). This information is conveyed to the controller 24 which in turn actuates and controls the printing mechanism 22 to compensate for this offset so that an accurate overprinting can be produced.

FIG. 3D shows still another example of a possible offset, which will be termed a size offset. Here, the size of the feature 14, or portions thereof, may be different than the intended size. In other words, the feature 14 may be appear somewhat enlarged or reduced in size versus the intended. In FIG. 3D, an enlargement offset is exemplified. For visualization purposes only, the actual positions 13a and 13b (indicating an enlargement in this example) will be displayed as having an x-direction offset as well. It can be noticed that the feature 14 is enlarged in relation to the enlargement of the registration markers 12a and 12b in their actual sizes 13a and 13b.

Once again, prior to applying the overprint, the imager 20 images the substrate 10 and thereby determines and quantifies the aforementioned enlargement, and there is a compensating effect applied by the overprinting system for this offset.

FIG. 3E shows another example of a possible offset, which will be termed an intensity offset. Here, the intensity of the feature 14, or portions thereof, may be different than the intended intensity, i.e. lighter or darker. For explanation purposes, to represent an increased intensity offset, i.e. bolder/darker than intended print appearing on the substrate 10, the actual intensity 13a and 13b is shown as having thicker dashed lines and slightly larger (and with positional offsets). Similarly, the feature 14 is shown having thicker lines. It should be understood that a faded or lighter feature 14 can also appear on the substrate 10 to be overprinted. Such offsets can occur, for example, due to printing errors, printing equipment issues (nozzle blockage, spurting, etc), due to exposure to environmental factors such as light and/or dirt, and for other reasons.

The intensity information is conveyed to the controller 24 by the imager 20, which in turn actuates and controls the printing mechanism 22 to compensate for the intensity offset, so that a proper overprinting is achieved.

FIG. 3F shows a still further example of a possible offset, which will be termed a color offset. Here, the color(s) of the feature 14, or portions thereof, may be different than the intended color(s), e.g. a different color or shade. Such offsets can occur, for example, due to printing errors, printing equipment issues (blockage of nozzles or portions of nozzles relating to certain color or colors), fading, cover-up or distortion as a result of exposure to environmental factors such as light and/or dirt, and for other reasons.

Sometimes the overprinting is the application of a symbol (or text, etc) adjacent the feature 14, and a matching of color with the feature, or a portion of it, is desired. Such an overprinting is also considered within the scope of this example.

The color(s) can be determined, for example, by the emitted wavelength of the registration markers 12a and 12b and/or feature(s) 14 previously printed on the substrate 10.

For explanation purposes, to represent an offset wherein the color is different than intended, the actual color 13a and 13b is shown as having curved dashed lines (and slightly larger and shifted to the right so those lines can be seen more easily). To represent an analogous relationship, the feature 14 is shown having lines made up of a sequence of curved segments.

The imager 20 conveys the color information to the controller 24 which in turn actuates and controls the printing mechanism 22 to compensate for the difference in color—so that a proper overprinting ink (varnish, etc) color is used.

If the offset is global, the registration markers 12a and 12b and the feature 14 will be affected in an analogous manner. Alternatively, the offset may be local. In other words, only some features 14, or portions thereof, may be affected (have an offset). Either way, the imager 20 can determine and quantify such offsets and correct for them. The correction can be in the form of adding or reducing the intensity (amount of ink, varnish, etc., and/or perhaps its color) overprinted on the feature 14, or portion thereof; or even blocking out unintended stray or miss-placed lines/marks.

FIGS. 3G and 3H illustrate examples of local offsets, by way of the feature 14 which is exemplified by a simply drawn house. In FIG. 3G, the house feature 14 is missing the top of its roof. This can be added during the overprinting. In addition to determining and compensating for all of the aforementioned type offsets and others not exemplified, if any, after the imager 20 images the substrate 10, the controller 24 compares the components of the feature 14 with a master substrate (not shown) whose data has been digitized and stored. As a result, the controller 24 determines that the roof top is missing and actuates the printing mechanism 22 to add it, in addition to any other overprinting applications.

An application of the aforementioned example is one wherein the overprinting completes or provides a portion of an electronic circuit, for example by printing an electronic ink to connect the ends of two portions of the electronic circuit.

FIG. 3H illustrates a slightly different issue. Here the rooftop of the feature 14 is in an incorrect position. The overprinting system performs a similar determination as just described, however, when overprinting, it must first delete the miss-positioned rooftop. This can be accomplished by determining the background color and overprinting that color on the miss-positioned rooftop in order to delete it, as well as overprinting the roof top as it should be.

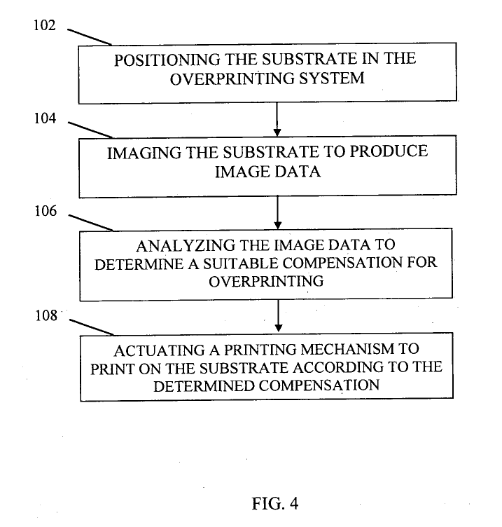

FIG. 4 is a flowchart illustrating an embodiment of a method for overprinting wherein offset issues are taken into account. In a first step 102, the substrate is fed or otherwise positioned on the platform 14 of the overprinting system. Then, in a subsequent step 104, the substrate 10 is imaged, including imaging the registration markers 12a and 12b and all features 14 on the substrate. In a next step 106, the imager 20 provides a digitized image (image data) of the substrate 10 to the controller 24 which receives and analyzes the data and determines what compensation is required, if any, to compensate for the offsets that may be present, in a step 108. The controller 24 then, in a step 110, actuates the printing mechanism 22 in a suitable manner, by way of signals for the printing mechanism 22 to apply ink (varnish, etc.) shifted linearly (x-y direction), angularly, to compensate for intensity issues, color issues, local anomalies, and the like. In a final step 112, the printing mechanism 22 applies ink (varnish, etc.) in accordance with the signals provided to it by the controller 20.

In accordance with particular embodiments, the method further comprises inputting data relating to the features 14 of the substrate 10 as they are intended to be. In the case where local anomalies are to be corrected, such inputting of data would be required.

It should be understood that the above description is merely exemplary and that there are various embodiments of the present invention that may be devised, mutatis mutandis.

1.-15. (canceled)

16. A method for adaptive overprinting, the method comprising:
determining one or more offsets from intended pre-determined properties of at least one registration mark placed on a substrate and from intended pre-determined properties of at least one other feature pre-printed on the substrate; and
overprinting content on the substrate based on the determined one or more offsets.

17. The method of claim 16, wherein determining the one or more offsets comprises:
capturing an image of the substrate with the at least one registration mark and the at least one other feature; and
determining the one or more offsets from the captured image of the substrate.

18. The method of claim 16, wherein determining the one or more offsets comprises:
computing one or more compensation adjustment values to be applied to pre-determined properties of the content to be overprinted.

19. The method of claim 16, wherein determining the one or more offsets comprises:
determining one or more spatial shifts from intended pre-determined positions of the at least one registration mark and the at least one other feature.

20. The method of claim 16, wherein determining the one or more offsets comprises:
determining one or more rotational shifts from intended pre-determined orientation of the at least one registration mark and the at least one other feature.

21. The method of claim 16, wherein determining the one or more offsets comprises:
determining one or more size shifts from intended pre-determined sizes of the at least one registration mark and the at least one other feature.

22. The method of claim 16, wherein determining the one or more offsets comprises:
determining one or more intensity shifts from intended pre-determined intensity levels of the at least one registration mark and the at least one other feature.

23. The method of claim 16, wherein determining the one or more offsets comprises:
determining one or more color shifts from intended pre-determined color levels of the at least one registration mark and the at least one other feature.

24. The method of claim 16, wherein overprinting the content on the substrate based on the determined one or more offsets comprises:
controlling one or more operations of a printer head to overprint the content on the substrate based on the one or more determined offsets.

25. The method of claim 24, wherein controlling the operations of the printer head comprises:
computing one or more compensation adjustment values to be applied to pre-determined properties of the content to be overprinted; and
actuating the printer head based on the computed one or more compensation adjustment values to cause the content to be printed in accordance with the one or more compensation adjustment values.

26. The method of claim 24, wherein controlling the one or more operations of a printer head to print the content on the substrate based on the one or more determined offsets comprises controlling one or more of: a spatial position of the content to be overprinted, a rotational shift in the orientation of the content to be printed, spatial size of the content to be overprinted, intensity levels of the content to be overprinted and color levels of the content to be overprinted.

27. The method of claim 16, further comprising:
recording in a log identification information associated with the substrate when the one or more determined offsets have values indicative that there is substantially no change in the required pre-determined properties of the at least one registration mark and the at least one other feature pre-printed on the substrate.

28. A system for adaptive overprinting of content on a substrate, the system comprising:
a controller configured to determine one or more offsets from intended pre-determined properties of at least one registration mark placed on the substrate and from intended pre-determined properties of at least one other feature pre-printed on the substrate; and
a printer to overprint the content on the substrate based on the determined one or more offsets.

29. The system of claim 28, further comprising:
an imager to capture an image of the substrate with the at least one registration mark and the at least one other feature;
wherein the controller configured to determine the one or more offsets is configured to determine the one or more offsets based on the captured image of the substrate.

30. The system of claim 28, wherein the controller configured to determine the one or more offsets is configured to perform one or more of:
compute one or more compensation adjustment values to be applied to pre-determined properties of the content to be overprinted;
determine one or more spatial shifts from intended pre-determined positions of the at least one registration mark and the at least one other feature;
determine one or more rotational shifts from intended pre-determined orientation of the at least one registration mark and the at least one other feature;
determine one or more size shifts from intended pre-determined sizes of the at least one registration mark and the at least one other feature;
determine one or more intensity shifts from intended pre-determined intensity levels of the at least one registration mark and the at least one other feature; and
determine one or more color shifts from intended pre-determined color levels of the at least one registration mark and the at least one other feature.

31. The system of claim 28, wherein the controller is further configured to:
control, based on the one or more determined offsets, one or more operations of a printer head of the printer to overprint the content on the substrate.

32. The system of claim 31, wherein the controller further configured to control the operations of the printer head is configured to:
compute one or more compensation adjustment values to be applied to pre-determined properties of the content to be overprinted; and
actuate the printer head based on the computed one or more compensation adjustment values to cause the content to be printed in accordance with the one or more compensation adjustment values.

33. An adaptive overprint system for providing an overprint upon a substrate, the substrate comprising a plurality of registration markers at predetermined locations thereon and at least one pre-printed feature, the system comprising:
an imager for capturing a digital image of said substrate with said registration markers and said feature;
a printing platform upon which the substrate resides during overprinting;
a printing mechanism for stamping said overprint upon said pre-printed feature;
a controller operatively connected to said imager and said printing mechanism; and
a handling device to move the substrate in and out of the printer;
wherein said controller is adapted to identify and calculate a shift in said pre-printed feature based on said image of the substrate received from said imager, and to calculate a correlating compensation or correction shift to be electronically applied to the overprinted image.

34. The overprint system according to claim 33, wherein the shift is selected from a group consisting of: a global shift, a local shift, a linear shift, an angular shift, a size shift, an intensity shift, a color shift, or any combination thereof.

35. A method of adaptive overprinting on a substrate having a plurality of registration markers at predetermined locations thereon that has been pre-printed with at least one feature, said feature having being printed with a shift, the method comprising:
a. obtaining an adaptive overprint system for providing an overprint upon a substrate, the substrate comprising a plurality of registration markers at predetermined locations thereon and at least one pre-printed feature, the system comprising:
an imager for capturing a digital image of said substrate with said registration markers and said feature;
a printing platform upon which the substrate resides during overprinting; a printing mechanism for stamping said overprint upon said pre-printed feature;
a controller operatively connected to said imager and said printing mechanism; and
a handling device to move the substrate in and out of the printer;
b. capturing a digital image of the substrate, comprising capturing said plurality of registration markers and said feature to be overprinted;
c. producing image data related to the shift in said captured image;
d. analyzing said image data to produce an appropriately shifted printing instructions; and
e. overprinting on the substrate in accordance with said shifted printing instruction, and thereby aligning said overprint with said pre-printed feature by shifting said overprint to match said original shift in said pre-printed feature.
